(19) United States
(12) Patent Application Publication
(10) Pub. No.: US 2025/0031619 A1
(43) Pub. Date: Jan. 30, 2025

(54) COTTON STRIPPER AIR SUPPLY SYSTEM

(71) Applicant: Deere & Company, Moline, IL (US)

(72) Inventors: Marcus A. JACOBSON, Ankeny, IA (US); Sachin C. BALLEWAR, Chandrapur (IN); Daniel J. JOHANNSEN, Des Moines, IA (US)

(73) Assignee: Deere & Company, Moline, IL (US)

(21) Appl. No.: 18/766,877

(22) Filed: Jul. 9, 2024

Related U.S. Application Data
(60) Provisional application No. 63/516,299, filed on Jul. 28, 2023.
(60) Provisional application No. 63/516,326, filed on Jul. 28, 2023.
(60) Provisional application No. 63/516,318, filed on Jul. 28, 2023.

(51) Int. Cl. A01D 46/10; A01D 46/12

(52) U.S. Cl. CPC A01D 46/10; A01D 46/12

(57) ABSTRACT

One or more techniques and/or systems are disclosed for harvesting cotton that includes an air supply system with a cotton flow accelerator having an air source and a nozzle having an inlet configured to receive air from the air source and an outlet configured to direct airflow pushing cotton away from a cross auger. The cotton flow accelerator further includes one or more ducts coupling the nozzle to the air source to form an air path therethrough, wherein the nozzle is coupled adjacent to the cross auger and directs the airflow to define a positive airflow at the cross auger.

### CROSS-REFERENCE TO RELATED APPLICATIONS

The present application is based on and claims the benefit of U.S. Provisional Patent application Ser. No. 63/516,318, filed Jul. 28, 2023, entitled COTTON STRIPPER AIR DUCT SYSTEM, Docket Number (016529-000168/P34701-US-PRO), Ser. No. 63/516,326, filed Jul. 28, 2023, entitled COTTON STRIPPER AIR DUCT SYSTEM, Docket Number (016529-000170/P34781-US-PRO), and Ser. No. 63/516,299, filed Jul. 28, 2023, entitled COTTON STRIPPER AIR SUPPLY SYSTEM, Docket Number (016529-0166/P34494-US-PRO), the contents of each of which are hereby incorporated by reference herein in their entirety.

### BACKGROUND

Harvester vehicles are used to harvest different crops, such as cotton. When using cotton strippers to harvest cotton, a cotton air system provides an induced airflow to move the cotton into the harvester vehicle and towards a cleaner system. As suction flow is used to move the harvested cotton crop into the harvester vehicle, the farther away from the air source, the less flow is induced. The induced flow is lowest at the exit of the header. Cotton can stagnate at this point and cause plugs.

### I. SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for harvesting crop with higher throughput using a positive airflow at the header outlet. In one implementation, a cotton flow accelerator for a cotton stripper comprises an air source and a nozzle having an inlet configured to receive air from the air source and an outlet configured to direct airflow pushing cotton away from a cross auger. The cotton flow accelerator further comprises one or more ducts coupling the nozzle to the air source to form an air path therethrough, wherein the nozzle is coupled adjacent to the cross auger and directs the airflow to define a positive airflow at the cross auger.

In any of the implementations herein, the nozzle comprises a curved portion that forms one or more of a generally J-shaped body; and/or a generally L-shaped body.

In any of the implementations herein, the nozzle comprises one or more of an outlet configured to direct airflow from a front of the cross auger and tangential to a bottom of the cross auger; an outlet configured to direct airflow at an angle relative to a bottom of the cross auger; and/or an outlet configured to introduce airflow at an exit of the cross auger.

In any of the implementations herein, the one or more ducts comprises an angled tube configured to connect in a plurality of different arrangements having different orientations relative to the cross auger.

In any of the implementations herein, the cotton flow accelerator further comprises a guard coupled adjacent to the nozzle.

In any of the implementations herein, the air source comprises a fan configured to supply air to a plurality of air pathways through different ducts of the one or more ducts, wherein the fan is configured to supply air to generate an additional airflow, wherein the additional airflow is a negative airflow downstream of the cross auger, wherein the fan comprises a plurality of rotors coupled to the different ducts.

In any of the implementations herein, the air source comprises a plurality of fans configured to supply air to a plurality of air pathways through different ducts of the one or more ducts.

In any of the implementations herein, the nozzle is configured to direct the airflow to define a positive airflow at the cross auger, whereby cotton is pushed out of an exit of the cross auger and into a cotton stripper lower transition duct.

In any of the implementations herein, the airflow is split into primary and secondary airflow paths comprising a negative airflow path operable to pull cotton through the cotton flow accelerator, and an additional positive airflow path operable to push the cotton through the cotton flow accelerator.

In another implementation, a harvester vehicle comprises a header system that includes a crop header component, wherein the crop header components comprises a cotton stripper header including a cross auger. The harvester vehicle further comprises an air system having an air source and operably coupled to, and in communication with, the header system. The air system further comprises a cotton flow accelerator including a nozzle having an inlet configured to receive air from the air source and an outlet configured to direct airflow pushing cotton away from a cross auger, and one or more ducts coupling the nozzle to the air source to form an air path therethrough, wherein the nozzle is coupled adjacent to the cross auger and directs the airflow to define a positive airflow at the cross auger.

In another implementation, a method for configuring a cotton flow accelerator in a cotton stripper comprises configuring a nozzle to provide a positive airflow at a cotton inlet, wherein the nozzle comprises a curved portion to direct the positive airflow. The method further comprises coupling the nozzle to a cross auger of the cotton stripper and to an air source and operating the nozzle to apply a pushing force at a header exit using the positive airflow.

In any of the implementations herein, the method for configuring the cotton flow accelerator in the cotton stripper further comprises coupling the cross auger of the cotton stripper to a negative airflow path operable to additionally pull cotton from the header exit using the negative airflow path.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

The examples disclosed herein may take physical form in certain parts and arrangement of parts, and will be described in detail in this specification and illustrated in the accompanying drawings which form a part hereof and wherein:

FIG. 1 is a component diagram illustrating a perspective view of a harvester vehicle having a cotton stripper according to an implementation.

FIG. 2 is a component diagram illustrating an airflow system with a cotton flow accelerator configured according to an implementation.

FIG. 3 is a diagram illustrating a cotton flow accelerator configured according to an implementation.

FIG. 4 is another diagram illustrating the cotton flow accelerator of FIG. 3.

FIG. 5 is another diagram illustrating a portion of the cotton flow accelerator of FIG. 3.

FIG. 6 is another diagram illustrating a portion of the cotton flow accelerator of FIG. 3.

FIG. 7 is a diagram illustrating airflow paths generated using the cotton flow accelerator shown in FIGS. 3-6.

FIG. 8 is another diagram illustrating the cotton flow accelerator of FIG. 3.

FIG. 9 is a diagram illustrating connection arrangements for cotton flow accelerators according to various implementations.

FIG. 10 is a diagram illustrating a seal according to an implementation.

FIG. 11 is a diagram illustrating another seal according to an implementation.

FIG. 12 is a diagram illustrating an another cotton flow accelerator configured according to an implementation.

FIG. 13 is a diagram illustrating a nozzle of the cotton flow accelerator of FIG. 12.

FIG. 14 is a diagram illustrating a guard according to an implementation.

FIG. 15 is a diagram illustrating a connection arrangement for the cotton flow accelerator of FIGS. 12-14.

FIG. 15A is a diagram illustrating a connection arrangement for the cotton flow accelerator of FIGS. 2-9 and/or the cotton flow accelerator of FIGS. 12-14.

FIG. 16 illustrates an example of a method for configuring an cotton flow accelerator according to an implementation.

FIG. 17 is a block diagram of an example computing environment suitable for implementing various examples.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form to facilitate describing the claimed subject matter.

The methods and systems disclosed herein, for example, may be suitable for use in different harvesters and harvesting applications. That is, the herein disclosed examples can be implemented in different harvesters other than for particular types of crops and/or harvesting systems (e.g., other than for specific farm harvester vehicles for particular harvesting applications, such as the herein described cotton harvester).

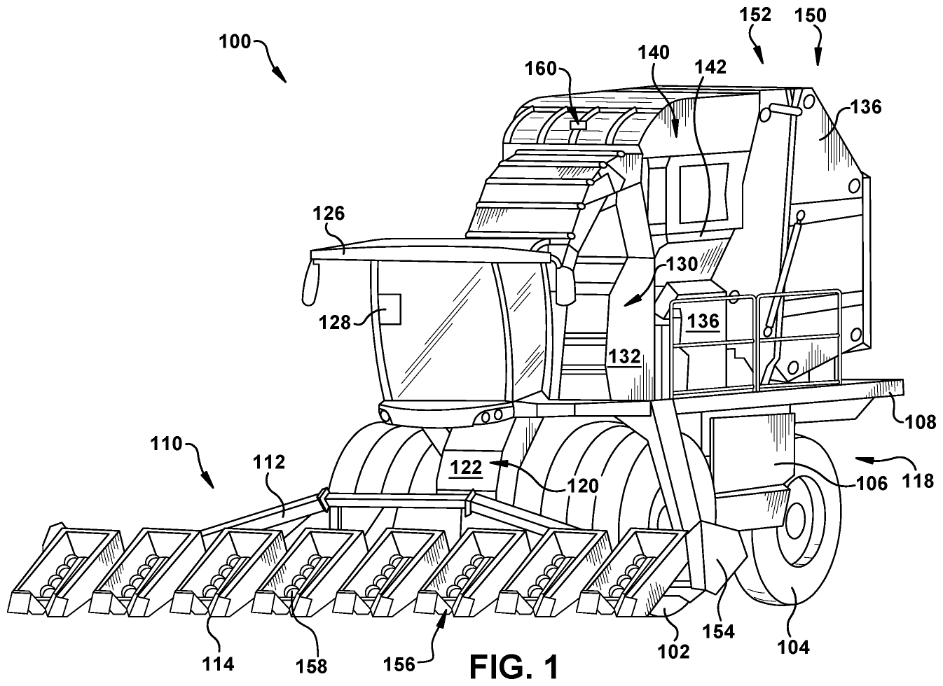

FIG. 1 illustrates an example harvester vehicle 100 that can utilize one or more portions of the aspects and examples described herein to harvest cotton. In this example, the harvester vehicle 100 is a cotton harvester with a cotton stripper, but other types of harvesters are contemplated by this disclosure.

The harvester vehicle 100 includes a chassis 108 that is supported by front wheels 102 and rear wheels 104, although other support is contemplated, such as tracks. A power module 118, such as an engine 106, is supported below the chassis 108 in the illustrated example. Water, lubricant, and fuel tanks (not shown) can be supported in and on the chassis 108. The harvester vehicle 100 is adapted for movement through a field to harvest crops, such as cotton in one or more examples.

An operator station 126 is also supported by the chassis 108. An operator interface 128 is positioned in the operator station 126. In some examples, the operator interface 128 includes or is configured as a controller that allows for controlling the operation or setting of one or more components of the harvester vehicle 100.

A plurality of crop harvesting devices 114 (illustrated as stripper row units) are coupleable to the chassis 108. The crop harvesting device 114 can be configured to remove cotton from a field in some examples. The crop harvesting device 114 in one or more examples includes a header system 110 a cotton stripper header 112 operable to strip cotton during harvesting using the crop harvesting devices 114. That is, a harvesting structure is thereby provided and coupleable to the chassis 108. In the illustrated example, the harvesting structure includes an auger housing 154 that is adjustably supported for vertical movement relative to the field. The harvesting structure is configured to remove cotton from the field.

The illustrated harvesting structure, including the header system 110, illustrates eight crop harvesting devices 114, that is, eight stripper row units. However, other numbers of crop harvesting devices 114 are contemplated, such as between eight to twelve crop harvesting devices 114. More crop harvesting devices 114 are also contemplated. Each of the crop harvesting devices 114 includes a row-receiving area 156 with a counter-rotating brush structure driven by hydraulic pressure for removing cotton plant material including cotton burrs and cotton fibers from cotton plants. The removed material is conveyed rearwardly by stripper row unit augers 158 in the crop harvesting devices 114 to a cross auger structure in an auger housing 154. It should be noted that the auger components can be provided using any suitable auger components for harvesting cotton.

It should also be noted that other devices are capable of being coupled to the harvester vehicle, such as one or more cotton picking units, or another harvesting structure (e.g., corn head, or other crop heads). The crop harvesting device 114 has different configurations (e.g., sizes, dimensions, etc.) depending on the type of crop being harvested and the manner of removing the crop from the field. In various herein described implementations, the harvester vehicle 100 is a cotton stripper equipped with the crop harvesting device 114 that is adapted to remove, or strip, cotton from the plant (instead of picking cotton from the plants).

The header system 110 further includes a crop header component that operably harvests a crop from a target field, a hydraulic motor or electric motor (not shown), and one or more sensors. In the illustrated example, the crop header component includes the cotton stripper header 112 configured to strip cotton. For implementations of the header system 110 that include a hydraulic motor, a hydraulic pump on the harvester vehicle 100 can drive the hydraulic motor on the cotton stripper header 112. In these implementations, the hydraulic motor supplies the power to rotate a shaft that drives individual harvesting units, as well as the cross augers that deliver cotton to the harvester vehicle 100. In other implementations, the electric motor supplies the power to rotate a shaft that drives individual harvesting units, as well as cross augers that deliver cotton to the harvester vehicle 100.

In some implementations, the harvester vehicle 100 includes an air system 120. The air system 120 in some examples includes a cotton flow accelerator (as described in more detail herein), a crop conveyor component that conveys the crop through the harvester vehicle 100, one or more sensors 160, and a crop conveyor device (e.g., one or more air ducts and an airflow generator). In some implementations as described in more detail herein, the crop conveyor component includes one or more air ducts 122 that provide a positive (or pushing) airflow (at a header outlet) in addition to an induced (or pulling) airflow. That is, one or more implementations introduce an additional airflow at the cross augers. For example, to improve commodity delivery to the air system 120 from header system 110 a high velocity airflow is supplied directly to the exit of the header cross auger. This additional airflow provides a positive source of air that prevents cotton from decelerating and stalling after being centrifugally separated from the header cross auger. As a result, the overall throughput capability of the air system 120 is increased in various examples. With this improved efficiency of the air system 120, the velocity at the finger grates or air exit can be reduced, which increases throughput and provides fuel savings in various examples.

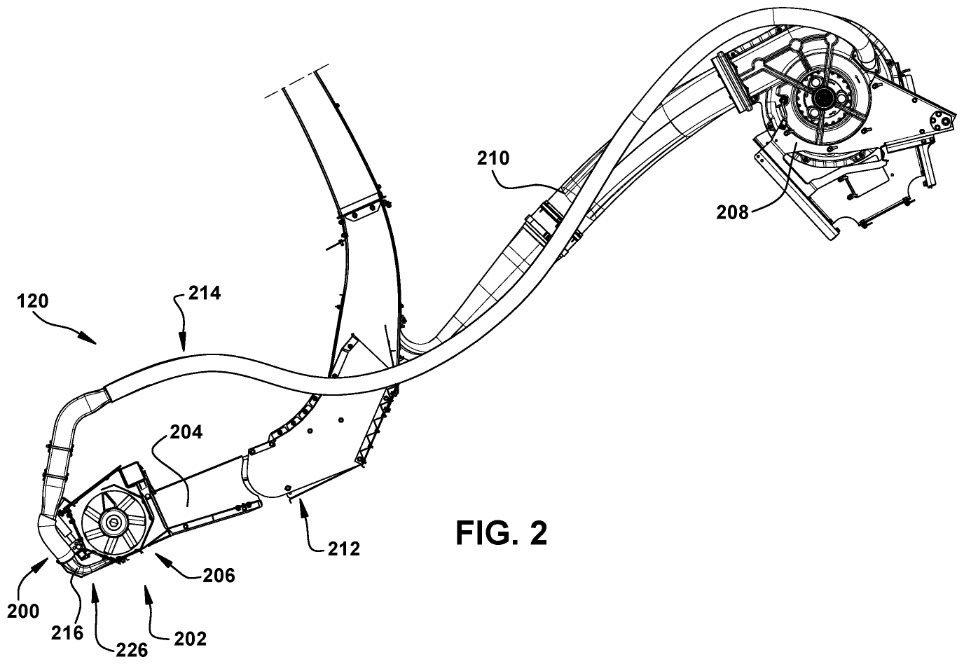

In some implementations, the air system 120 is operably coupled to, and in communication with, the header system 110. In these implementations, the air duct 122 is coupled to, and aligned with the cotton stripper header 112, so that the cotton stripped by the cotton stripper header 112 can be transported into the harvester vehicle 100 from the cotton inlet through the air ducts 122 of the air system 120 powered by multiple airflows (e.g., multiple airflows from one or more air generators). One implementation of the air system 120 is shown in FIG. 2 and is operable as a cotton inlet flow accelerator configured to introduce air at the cross auger.

The one or more sensors 160 can be configured to monitor airflow and/or crop mass flow in the air ducts 122 of the air system 120. In some implementations, one or more of the sensors 160 can be positioned in the air ducts 122. As an example, the harvester vehicle 100, configured as a cotton stripper, includes a plurality of the sensors 160 (e.g., flow sensors) that are mounted across the width of the air ducts 122 (which may be at one or more inlets or outlets). In other implementations, one or more of the sensors 160 can be positioned adjacent the air ducts 122. As an example, the harvester vehicle 100, such as the cotton stripper, includes a plurality of mass flow sensors 160 that are mounted behind the air ducts 122 with one cotton mass flow sensor mounted per row unit. The airflow, and/or crop mass flow, can be monitored using various types of sensors.

In some implementations, the harvester vehicle 100 includes a cleaner system 130. In some examples, the cleaner system 130 includes a crop cleaner component that operably cleans the harvested crop, a hydraulic motor or electric motor (not shown), and one or more sensors. In some implementations, the crop cleaner component includes a cleaner 132 that is configured to clean cotton from the cotton stripper header 112 by removing trash and debris. For implementations of the cleaner system 130 that include a hydraulic motor, a hydraulic pump on the harvester vehicle 100 drives the hydraulic motor on the cleaner 132.

In some implementations, the cleaner system 130 is operably coupled to, and in communication with the header system 110 via the air system 120. In these implementations, the cleaner 132 is coupled to, and aligned with, the air duct 122 so that the cotton stripped by the cotton stripper header 112 can be transported into the cleaner 132 through the air ducts 122 of the air system 120 powered by airflow.

A crop receptacle 152 is coupleable to the air system 120 in various implementation. In one or more examples, the crop receptacle 152 is a module builder 150 having at least one baler belt (not shown). As an example, the module builder 150 can be used to build a module of the crop, such as a bale of cotton or hay/straw, etc. In other implementations, the crop may be ejected by the air system 120 into an internal hopper, and/or ejected from the harvester into an accompanying holding tank.

The harvester vehicle 100 further includes an accumulator system 140. The accumulator system 140 in some examples includes a crop accumulator component that operably, temporarily stores the harvested crop. In some implementations, the crop accumulator component includes an accumulator 142. The accumulator 142 is configured to receive cotton, or other crop, harvested by the cotton stripper header 112 or the cotton picking units 116.

In some implementations, the accumulator system 140 is operably coupled to, and in communication with the cleaner system 130. In these implementations, the harvested crop can be transported (e.g., powered by airflow from an air generator) from the cleaner 132 into the top of the accumulator 142 such that the accumulator 142 fills from the bottom up.

In various examples, a feeder 136 is also coupleable to the chassis 108. The feeder 136 can be configured to receive cotton, or other crop, from the accumulator 142. The feeder 136 includes a plurality of rollers configured to compress the cotton, or other crop, and transfer the cotton, or other crop, to the module builder 150 at a feed rate.

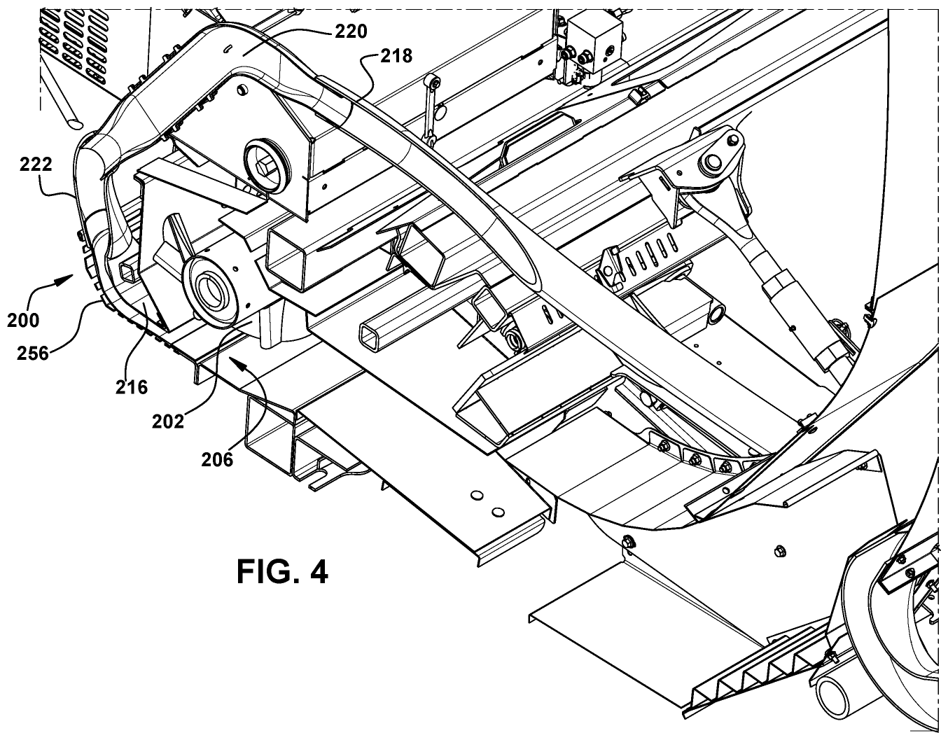

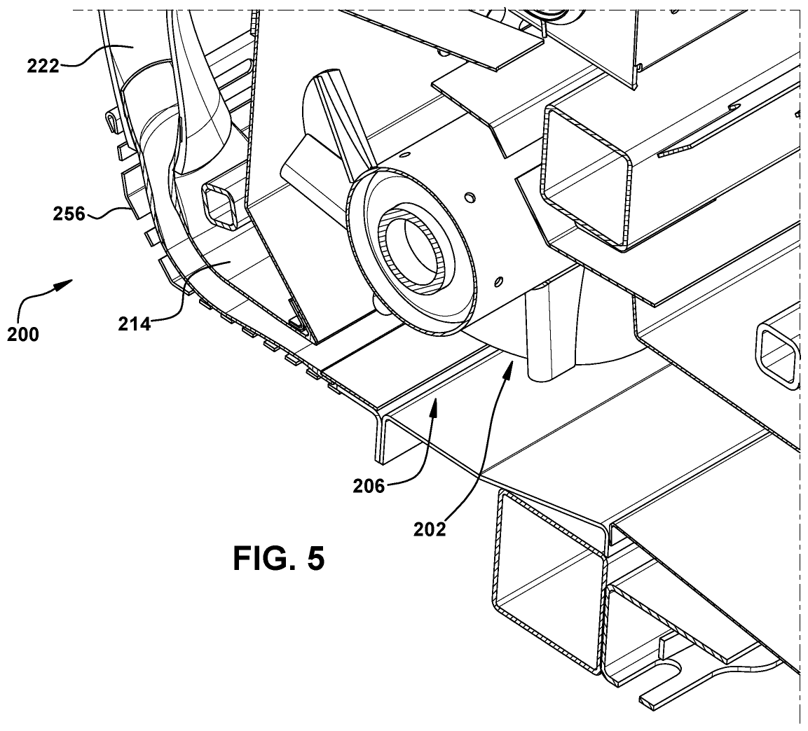

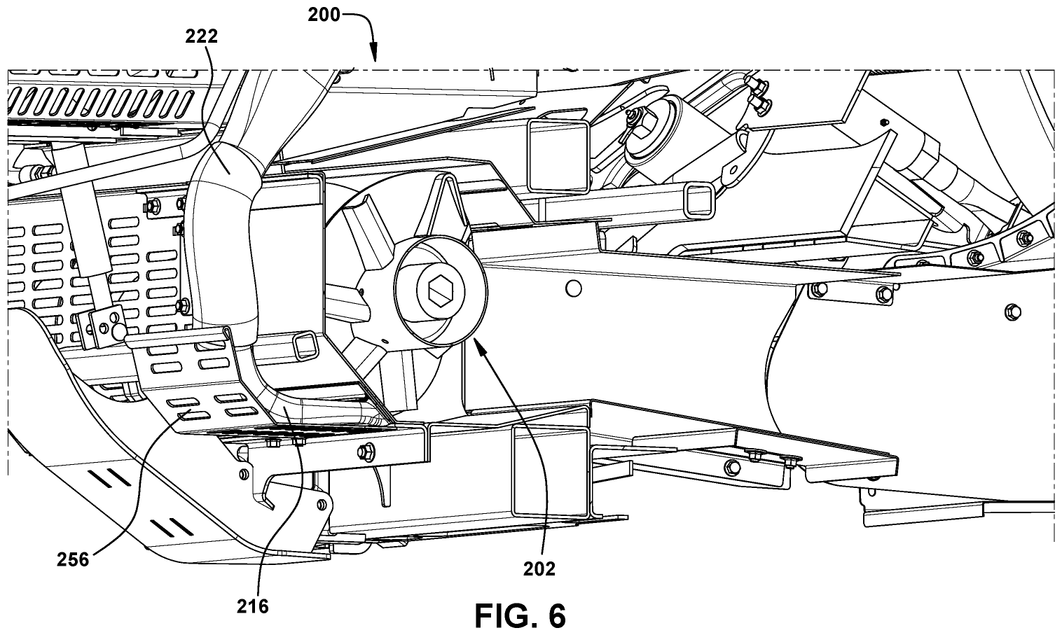

With particular reference to FIGS. 2-9, the air system 120 in some examples has a cotton flow accelerator 200 (which accelerates airflow in some examples) that adds pushing or positive air to the cotton being harvested at a cross auger 202 (which may form part of or be embodied as the cross auger structure in the auger housing 154 as shown in FIG. 1), such as pushing cotton away from the cross auger 202, to facilitate movement of the harvested cotton into a higher suction area 204 of the air system 120 as described in more detail herein. As a result, the induced airflow (or negative or suction airflow) in various examples can be reduced. For example, in some implementations, the cotton flow accelerator 200 is configured to apply a high velocity airflow directly to an exit 206 of the cross auger 202 (e.g., the header cross auger). The applied airflow in some examples prevents cotton from decelerating and stalling after being centrifugally separated from the cross auger 202, which increases the overall throughput capability of the air system 120. That is, with the improved efficiency of the air system 120, the main airflow at the finger grates can have a reduced velocity, thereby resulting in less crop lost (e.g., from cotton being blown past or through the finger grates).

As can been seen more particularly in FIG. 2, airflow from an air source, illustrated as a fan 208 is directed through a first duct 210 (e.g., a plastic air duct) to a downstream exit of a cotton stripper lower transition duct 212, which creates a suction airflow (negative airflow) or force from the cross auger 202 and through the cotton stripper lower transition duct 212. That is, the first duct 210 in some examples is coupled to the fan 208 and in communication with an exit of the cotton stripper lower transition duct 212 (e.g., connected to an exit duct) to provide a main airflow supply to create the suction that moves the cotton into the harvester vehicle 100 from the cross auger 202 (that is configured to receive cotton therefrom). In the illustrated example, a second duct 214 is coupled to the fan 208 and in communication with an exit of the cross auger 202 (e.g., connected to an exit portion of the cross auger and tangent to the cotton flow path). In some implementations, the second duct 214 is connected to a nozzle 216 at a front of the cross auger 202, and illustrated as tangent to a lower end of the cross auger. In this configuration, airflow is directed from the fan 208 directly to the exit 206 of the cross auger 202. That is, a separate airflow is introduced at the cross auger 202 to provide a positive or pushing airflow of the cotton at the cross auger 202 (e.g., at the header outlet to push cotton away from the cross auger 202). In various examples, the nozzle 216 (or other nozzle as described herein) preserve the airflow cross-section.

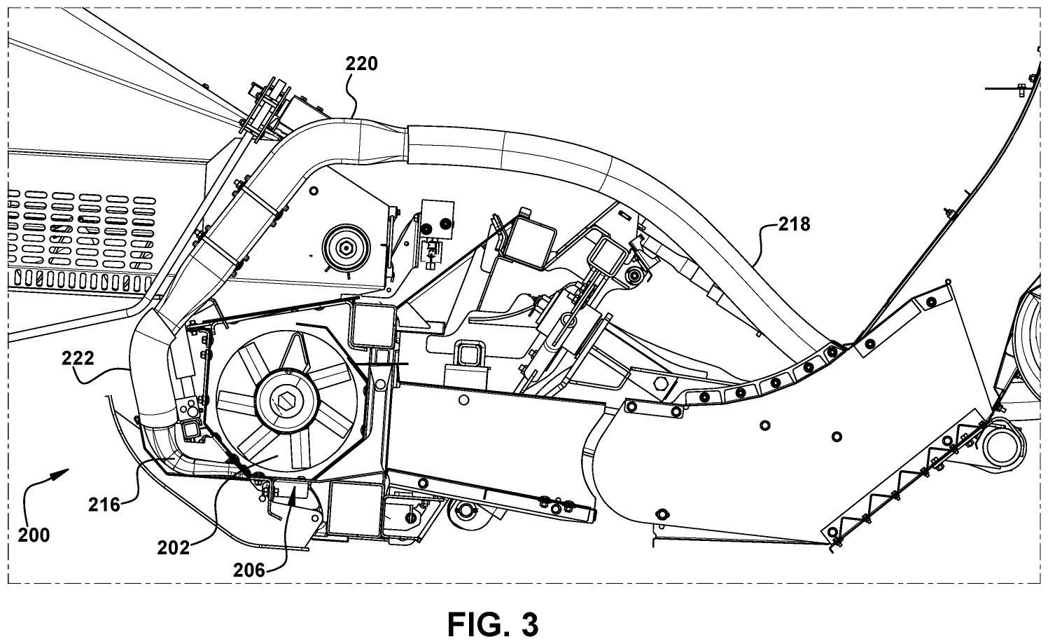

In some examples (see FIG. 3), the second duct 214 is a multi-tube structure having a supply tube 218 connected to one end of a rigid conduit 220 and an angled tube 222 connected to the other end of the rigid conduit 220 and then to the nozzle 216. That is, the second duct 214 in some examples is configured to provide an airflow over or above the auger structure and then back towards a front of the auger structure to supply the airflow in an exit direction of the cross auger 202. In this configuration, as the cross auger 202 rotates in a counterclockwise direction to harvest the cotton, the airflow in the same direction facilitates movement of the cotton into the cotton stripper lower transition duct 212. In some examples, the cotton stripper lower transition duct 212 is configured having baffles (e.g., baffles that can have different shapes and/or sizes) or other obstructing members that facilitate cotton flow while deflecting or regulating flow or passage of unwanted or non-desired material from within the cotton stripper lower transition duct 212. In some examples, the cotton stripper lower transition duct 212 has a generally continuously curved passageway to facilitate flow of cotton therethrough. However, it should be appreciated that the various examples described herein can be used with different air systems having different component parts, such as different cotton stripper lower transition ducts.

As can be seen, the nozzle 216 has an inlet and an outlet and is oriented downward (as viewed in FIG. 2) and curved toward the cross auger 202 such that the outlet of the nozzle 216 is directed across and tangential to the cross auger 202. That is, the nozzle 216 has a curved portion 226 (e.g., a body having a curvature between two planar ends with a generally “L” shaped (L-shaped) profile and having a constant or varying diameter or width) that causes the airflow to pass around the cross auger 202 and enter from a front side thereof to provide a positive or pushing airflow. It should be noted that the curved portion 226 can have a different curvature than shown, for example, to define a more or less arcuate airflow path. Additionally, the planar portions of the nozzle 216 (or other nozzles) can have a rectangular or other shape.

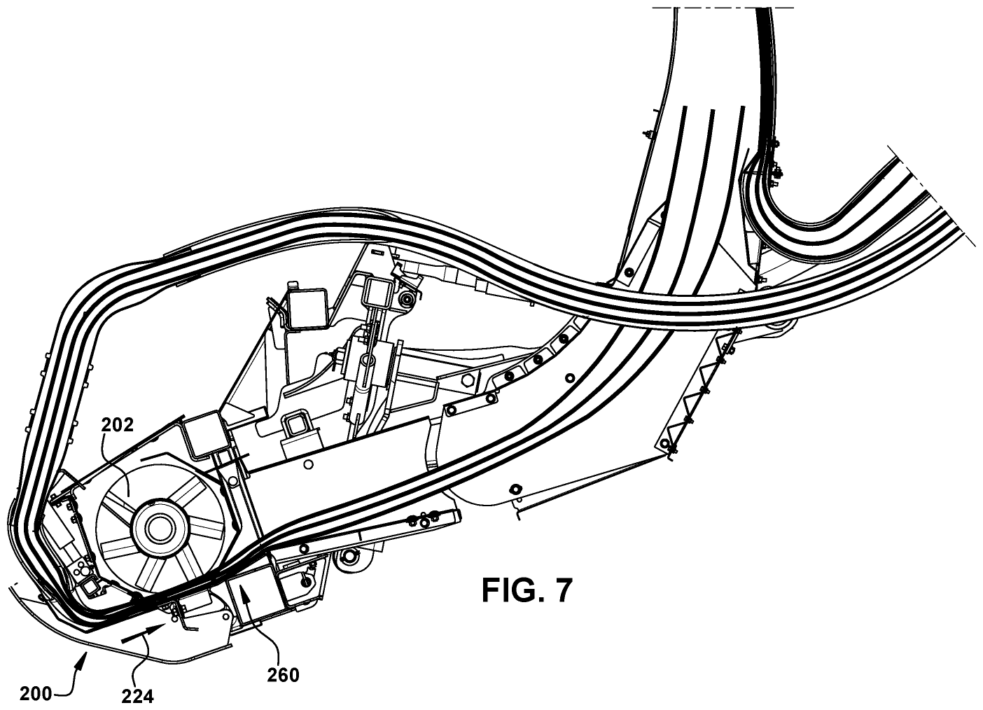

In various examples, the nozzle 216 has airflow directed tangential to the bottom of the cross auger 202 from the nozzle 216 such that cotton is pushed out of the exit of the cross auger 202 and into the cotton stripper lower transition duct 212. As such, a positive airflow path 224 is created as shown in FIG. 7 that allows stronger airflow at the front end of the cross auger 202, and accordingly, the suction force can be lowered. That is, the airflow directed through the first duct 210 to a downstream exit of a cotton stripper lower transition duct 212 is reduced (as less suction is needed with the positive airflow created by the nozzle 216), which increases the amount of cotton harvested (less cotton blown through the cross auger 202 as a result of lower suction force), and also resulting in fuel savings. In some examples, a more balanced airflow system is thereby provided.

As can be seen (see, e.g., FIG. 2), in the illustrated example, the second duct 214 is coupled to one side of the fan 208 (e.g., to one side rotor of the fan 208). That is, positive airflow at the nozzle 216 is provided using a supplemental (or secondary) airflow path generated from the same air source used to generate the primary airflow path through the first duct 210 that creates the suction air as described in more detail herein. It should be appreciated that the air source for the nozzle 216 can be provide using any suitable means and is not limited to the single air supply as illustrated. For example, a separate air supply (e.g., a separate fan) is provided in some configurations to generate the airflow to the nozzle 216. The one or more air supplies can be configured and positioned differently than shown, for example, based on the type of harvester vehicle, the configuration of the air system 120, etc.

In some example, a plurality of cotton flow accelerators 200 are provided. That is, separate supplies of positive air to different portions of the cross auger structure can be provided. For example, more than one of stripper row unit augers 158 can be provided with the positive airflow using a corresponding cotton flow accelerator 200 (and nozzle 216). In some examples, selective ones of the stripper row unit augers 158 are provided with the cotton flow accelerators 200, such as end units, every other unit, etc. It should be appreciated that any configuration and number or cotton flow accelerators 200 can be provided as desired or needed.

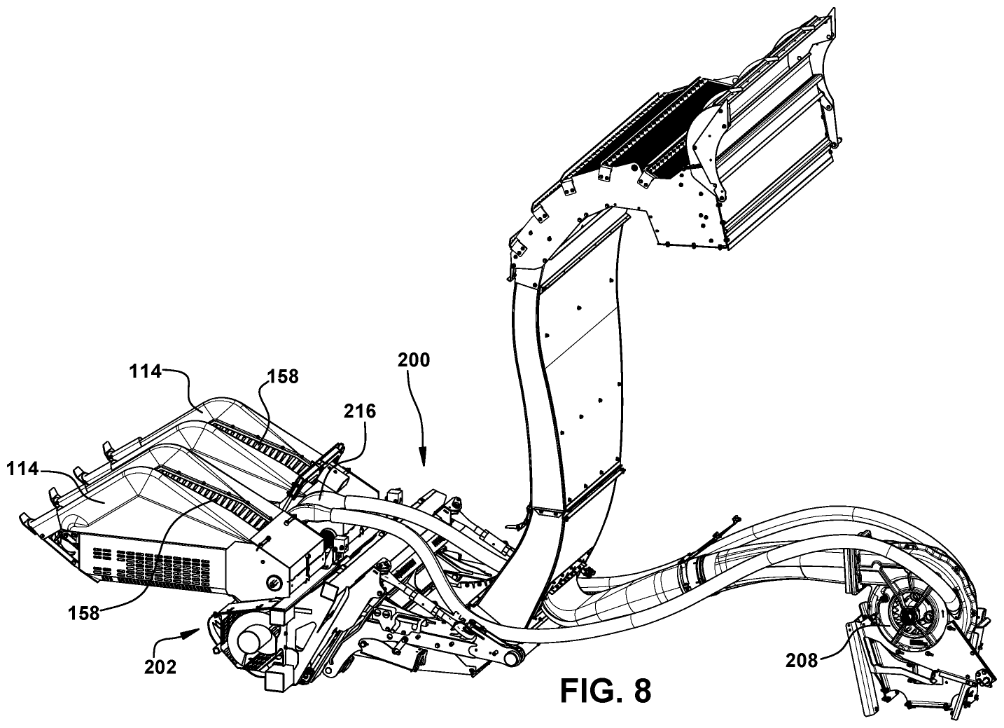

In configurations having more than one cotton flow accelerator 200, the air source for the multiple cotton flow accelerators 200 can be provided from a single supply (e.g., a single fan 208) or multiple supplies. As can be seen in FIG. 8, for example, the fan 208 provides the primary airflow and two additional airflow sources from opposite sides of the fan 208 (e.g., from opposing rotors of the fan 208). That is, separate connections or outlets for supplying the airflow to the cotton flow accelerators 200 from the fan 208 are provided. However, separate air supplies can be provided and/or the single air supply can be used to provide airflow to more than two cotton flow accelerators 200.

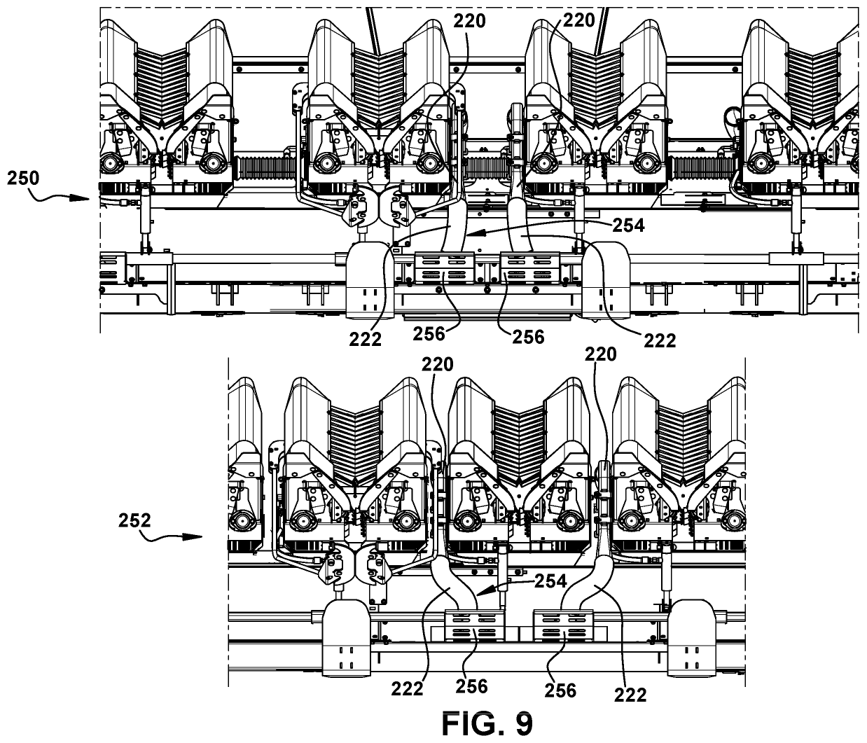

In some examples, the cotton flow accelerators 200 are configured to provide connection to adjacent stripper row unit augers 158 (e.g., to a pair of the stripper row unit augers 158) having different spacing and/or widths by adjusting one or more components of the stripper row unit augers 158 as can be seen in the connection arrangements 250, 252 illustrated in FIG. 9. In the illustrated examples, the connection arrangement 250 shows cotton flow accelerators 200 coupled to stripper row unit augers 158 having a different width than the stripper row unit augers 158 in the connection arrangement 252. That is, the cotton flow accelerators 200 have components parts that are configured to allow for connection to the stripper row unit augers 158 in different configurations. As such, the herein described duct structures can be easily modified to couple to different arrangements of the cross auger structure.

For example as can be seen in FIG. 8, the angled tube 222 can be connected to the end of the rigid conduit 220 in different positions or orientations, such that connection then to the nozzle 216 can be provided for different types of stripper row unit augers 158 (e.g., different sizes of stripper row unit augers 158). As can be seen, in the connection arrangement 250, a set of two angled tubes 222 are arranged to pass between pairs of the stripper row unit augers 158 and then inward toward the nozzles 216 positioned at the cross auger structure. Whereas, in the connection arrangement 252, the angled tubes 222 are arranged such that a single angled tube 222 is arranged to pass between adjacent pairs of the angled tubes 222 and then outward toward the nozzles 216 positioned at the cross auger structure. As such, the angled tube 222 can be rotated or oriented to provide a curved region 254 aligned differently with the stripper row unit augers 158 to allow connection in different configurations of the cross auger structure (e.g., angled at a greater or lesser degree depending on the configuration of the stripper row unit augers 158), such as based on the width and/or spacing between stripper row unit augers 158. It should be appreciated that in some examples a guard 256 (e.g., a shield) is also provided to prevent debris or other material from hitting one or more components of the cotton flow accelerators 200 (e.g., the nozzles 216). That is, the guard 256 is coupled to an underside of the cross auger structure to protect the components of the cotton flow accelerators 200 from damage during operation (e.g., from rocks striking the underside of the stripper row unit augers 158).

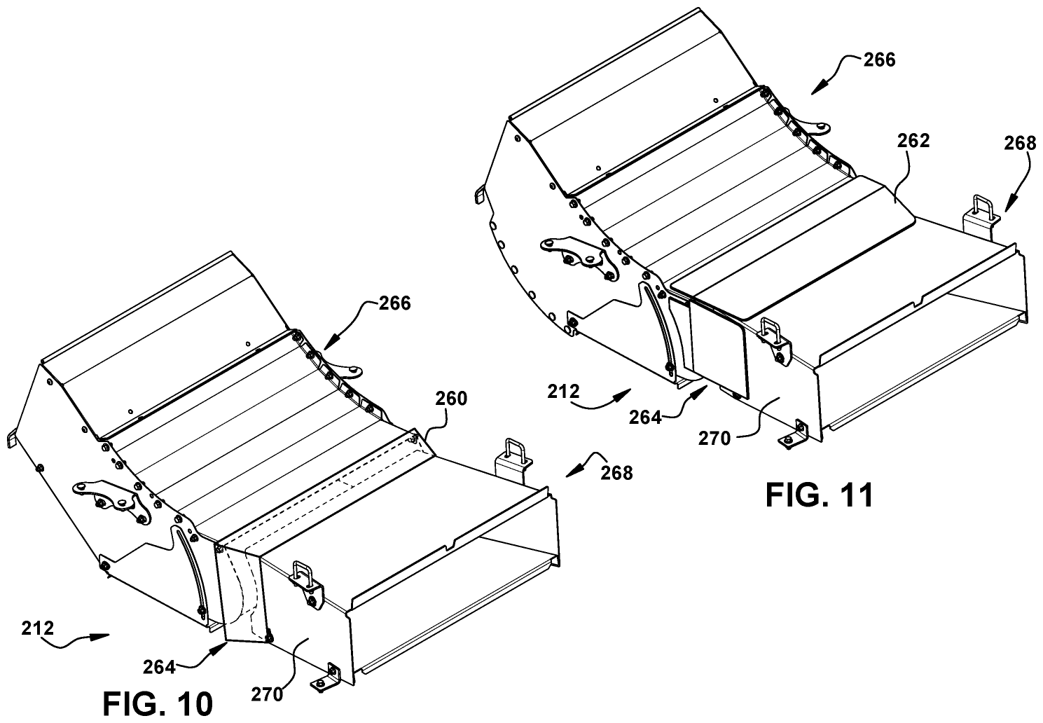

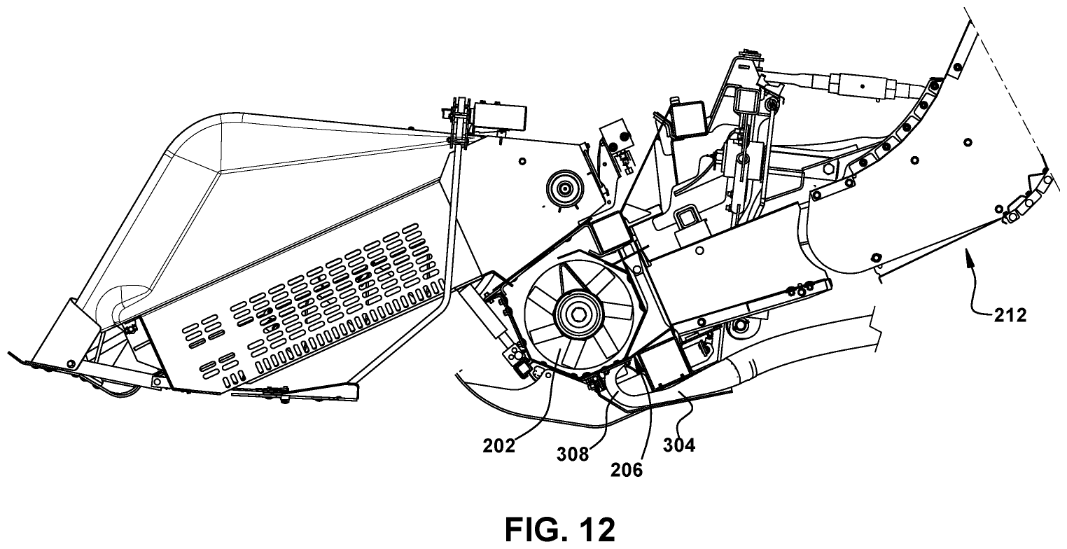

In some examples, the positive air supply provided by the cotton flow accelerators 200 allows for a more closed duct structure along the airflow path. That is, openings at different locations along the duct structure through which cotton is harvested can be closed as a sufficient airflow is provided with the combination of air paths as described herein. For example, as can be seen in FIGS. 10 and 11 a seal 260, 262 (e.g., a flexible sealing structure) is provided along the airflow path. More particularly, a gap 264 is provided between a first portion 266 and a second portion 268 of the cotton stripper lower transition duct 212 that allows, in part, movement between the first portion 266 and the second portion 268 (e.g., the second portion 268 pivots with respect to the first portion 266 to be oriented towards the ground). As can be seen, at least a portion of the gap 264 is covered or sealed by the seal 260, 262 such that no (or a reduced amount of) exposed space (e.g., closed opening) is provided between the first portion 266 and the second portion 268. That is, the leading end of the second portion 268 is engaged with the trailing end of the first portion 266, such that only the cotton inlet opening at the cross auger structure is provided.

The closing of the gap 264 can be provided in any suitable manner, such as by using any type of sealing member (e.g., a flexible sealing member or a sealing flap), extending along a length of the second portion 268 towards the first portion 266, etc. In the configuration illustrated in FIG. 10, the seal 260 comprises flexible flaps that pulls onto the receiving duct (the first portion 266) as the suction airflow is created as described in more detail herein. As can be seen, the seal 260 is a flexible sealing structure that allows movement between the first portion 266 and the second portion 268. That is, the seal 260 is configured to allow a receiving duct 270 of the second portion 268 to move upward and downward and pivot with lateral tilt header movement of the receiving duct 270.

Similarly, the seal 262 illustrated in FIG. 11 comprises a flexible or movable structure having flexible flaps that pull onto the receiving duct (the first portion 266) as the suction airflow is created as described in more detail herein. As can be seen, the seal 262 is a flexible sealing structure that allows movement between the first portion 266 and the second portion 268. That is, the seal 262 is configured to allow a receiving duct 270 of the second portion 268 to move upward and downward and pivot with lateral tilt header movement of the receiving duct 270 as a result of the material flexibility of the seal 262.

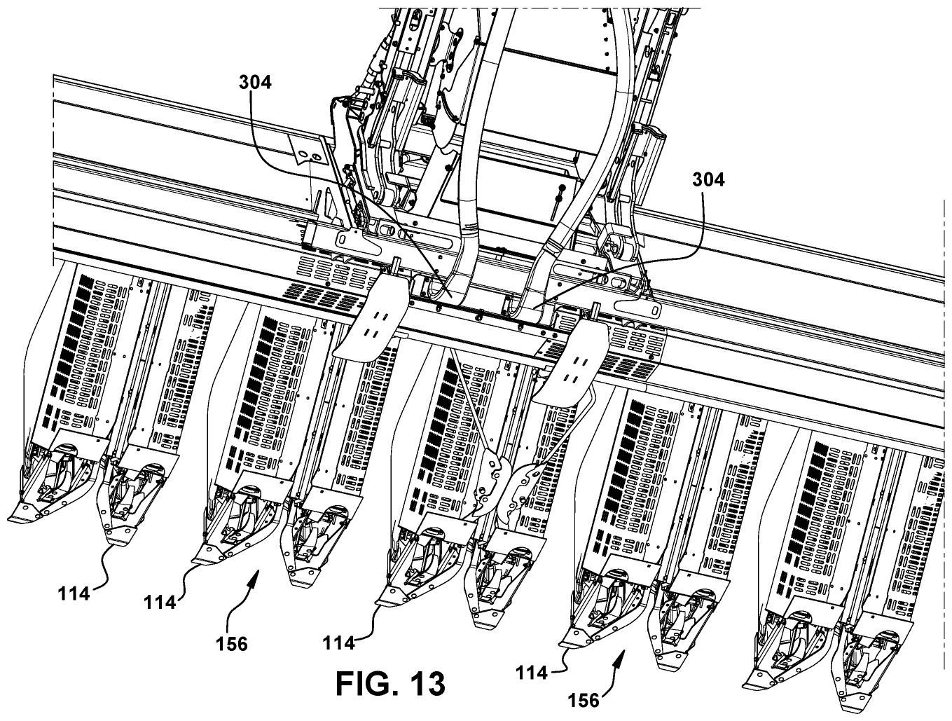

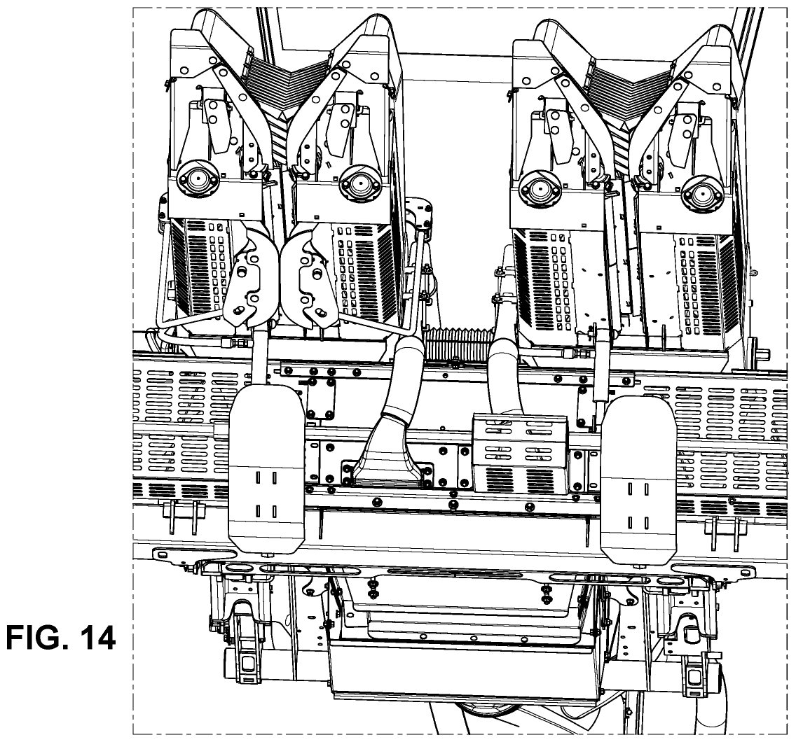

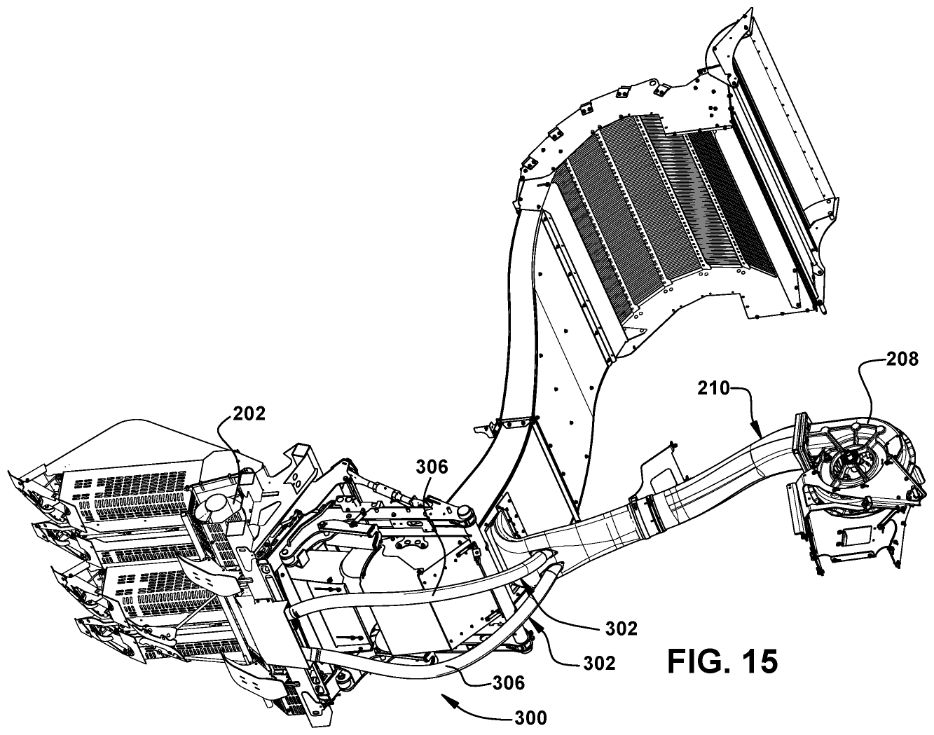

Different configurations of airflow accelerators are contemplated. That is, airflow accelerators having different arrangements can be provided to generate the pushing airflow (positive airflow) at the cross auger structure. For example, FIG. 12-16 illustrate a cotton flow accelerator 300 that can be used or form part of the air system 120 that is configured as a cotton inlet flow accelerator that adds pushing or positive air to the cotton being harvested at the cross auger 202 (which may form part of or be embodied as the cross auger structure in the an auger housing 154 as shown in FIG. 1) to facilitate movement of the harvested cotton into the higher suction area 204 of the air system 120 as described in more detail herein. As a result, the induced airflow (or negative or suction airflow) in various examples also can be reduced in this configuration. For example, in some implementations, the cotton flow accelerator 300 is configured to apply a high velocity airflow directly to the exit 206 of the cross auger 202 (e.g., the header cross auger). The applied airflow in some examples prevents cotton from decelerating and stalling after being centrifugally separated from the cross auger 202 (similar to the configuration shown in FIGS. 2-9), which increases the overall throughput capability of the air system 120. That is, with the improved efficiency of the air system 120, the main airflow at the finger grates can have a reduced velocity, thereby resulting in less crop lost (e.g., from cotton being blown past or through the finger grates).

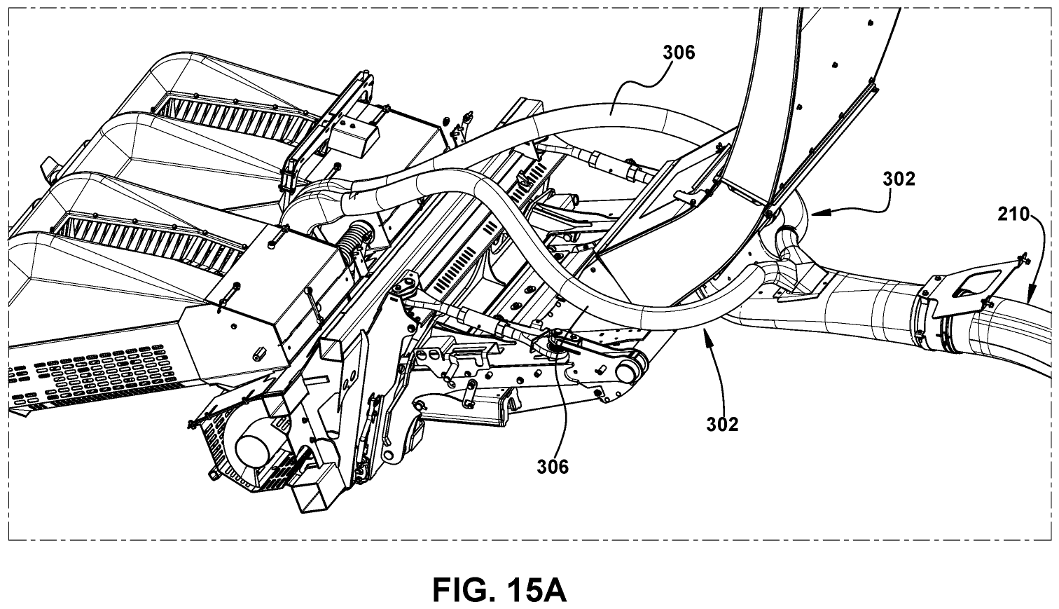

As can been seen more particularly in FIGS. 12, 15, and 15A airflow from an air source, illustrated as the fan 208 (FIG. 15) is directed through the first duct 210 to the downstream exit of a cotton stripper lower transition duct 212, which creates a suction airflow or force from the cross auger 202 and through the cotton stripper lower transition duct 212. That is, as described in more detail herein, the first duct 210 in some examples is coupled to the fan 208 and in communication with an exit of the cotton stripper lower transition duct 212 (e.g., connected to an exit duct) to provide a main airflow supply to create the suction that moves the cotton into the harvester vehicle 100 from the cross auger 202 (that is configured to receive cotton therefrom).

In the illustrated example, a second duct 302 (two of which are shown in the illustrated examples) is coupled to the fan 208 and in communication with an exit of the cross auger 202 (e.g., connected to an exit portion of the cross auger and tangent to the cotton flow path). In some implementations, the second duct 302 is connected to a nozzle 304, at a bottom of the cross auger 202, that curves upward from a lower end of the cross auger. In this configuration, airflow is directed from the fan 208 directly to the exit 206 of the cross auger 202. That is, a separate airflow is introduced at the cross auger 202 to provide a positive or pushing airflow of the cotton at the cross auger 202.

In some examples, the second duct 302 is a tube structure having a supply tube 306 connected to the nozzle 304. It should be noted that any type of air supply conduit or pathway can be provided in the various examples, including using a single or multi-component configuration (e.g., multiple tubes). In the examples, the nozzle 304 is shaped to provide an airflow from below the auger structure and then upwards towards a back end of the auger structure to supply the airflow in an exit direction of the cross auger 202. In this configuration, as the cross auger 202 rotates in a counterclockwise direction to harvest the cotton, the airflow in the same direction facilitates movement of the cotton into the cotton stripper lower transition duct 212. It is to be appreciated that the supply tube 306 illustrated in FIGS. 15 and 15A may equivalently be connected with a nozzle 216 at a front of the cross auger 202, and being tangent to a lower end of the cross auger. In this configuration, airflow is directed via the first duct 210 from the fan 208 to the exit 206 of the cross auger 202. That is, a separate airflow is introduced at the cross auger 202 to provide a positive or pushing airflow of the cotton at the cross auger 202 (e.g., at the header outlet to push cotton away from the cross auger 202). In various examples, the nozzle 216 (or other nozzles as described herein such as for example nozzle 304) preserve the airflow cross-section.

More particularly, as can be seen in the various FIGURES, the nozzle 304 is oriented parallel to the cotton stripper lower transition duct 212 and then curved upward toward the cross auger 202, such that an outlet of the nozzle 304 is directed at an angle from below the exit of the cross auger 202. That is, airflow is directed at an angle from the bottom of the cross auger 202 using the nozzle 304, such that cotton is pushed out of the exit of the cross auger 202 and into the cotton stripper lower transition duct 212. In this example, the nozzle 304 configuration allows stronger airflow at the bottom back end of the cross auger 202, and accordingly, the suction force can be lowered. For example, the airflow directed through the first duct 210 to a downstream exit of a cotton stripper lower transition duct 212 is reduced (as less suction is needed with the positive airflow created by the nozzle 304), which increases the rate of cotton harvested, and also resulting in fuel savings. In some examples, a more balanced airflow system is thereby provided.

In this example, the nozzle 304 has a curved end portion 308 that extends from a planar portion (e.g., a body having a generally “J” shaped (J-shaped) profile having a constant or varying diameter or width) that causes the airflow to pass below the cross auger 202 and enter from a bottom side thereof to provide a positive or pushing airflow. In various examples, the nozzle 304 has airflow directed from the bottom of the cross auger 202, such that cotton is pushed out of the exit of the cross auger 202 and into the cotton stripper lower transition duct 212. As such, a positive airflow path is created similar to the cotton flow accelerator 200 and as described in more detail herein, but with the flow provided at a different location and orientation with respect to the cross auger 202. It should be appreciated that different configurations of airflow accelerators including differently configured nozzles are contemplated, such as based on the type, configuration, application, etc. of the harvester vehicle or harvester equipment. The differently configured nozzles for use with the supply tubes 306 of the various implementations may include for example the nozzle 216 described above having an inlet and an outlet that is oriented downward (as viewed in FIG. 2) and curved toward the cross auger 202 such that the outlet of the nozzle 216 is directed across and tangential to the cross auger 202. That is, the nozzle 216 for use with the supply tubes 306 of the various implementations may have a curved portion 226 (e.g., a body having a curvature between two planar ends with a generally “L” shaped (L-shaped) profile and having a constant or varying diameter or width) that causes the airflow to pass around the cross auger 202 and enter from a front side thereof to provide a positive or pushing airflow. It should be noted that the curved portion 226 can have a different curvature than shown, for example, to define a more or less arcuate airflow path. Additionally, the planar portions of the nozzle 216 (or other nozzles) can have a rectangular or other shape.

As can be seen, in the illustrated example, the second duct 302 is coupled to one side of the fan 208 (e.g., to one side rotor of the fan 208). That is, positive airflow at the nozzle 304 is provided using a supplemental (or secondary) airflow path generated from the same air source used to generate the primary airflow path through the first duct 210 that creates the suction air as described in more detail herein (and defining different air pathways in some examples). It should be appreciated that the air source for the nozzle 304 can be provide using any suitable means and is not limited to the single air supply as illustrated. For example, a separate air supply (e.g., a separate fan) is provided in some configurations to generate the airflow to the nozzle 304. The one or more air supplies can be configured and positioned differently than shown, for example, based on the type of harvester vehicle, the configuration of the air system 120, etc.

In some examples, a plurality of cotton flow accelerators 300 are provided. That is, separate supplies of positive air to different portions of the cross auger structure can be provided. For example, more than one of stripper row unit augers 158 can be provided with the positive airflow using a corresponding cotton flow accelerator 300 (and nozzle 304). In some examples, selective ones of the stripper row unit augers 158 are provided with the cotton flow accelerators 300, such as end units, every other unit, etc. It should be appreciated that any configuration and number or cotton flow accelerators 300 can be provided as desired or needed.

In configurations having more than one cotton flow accelerator 300, the air source for the multiple cotton flow accelerators 300 can be provided from a single supply (e.g., a single fan 208) or multiple supplies. As can be seen in FIGS. 15 and 15A, for example, the fan 208 provides the primary airflow and two additional airflow sources from the fan 208. That is, separate connections or outlets for supplying the airflow to the airflow cotton flow 300 from the fan 208 are provided by connecting directly to a portion of the first duct 210 in these examples. That is, the nozzles 304 are fluidly coupled to the fan 208 via the first duct 210 by way of the supply tubes 306. As can be seen in the implementation of FIG. 15, the supply tubes 306 in this example are coupled to the bottom side of a lower end of the first duct 210. In addition, and as can be seen in the implementation of FIG. 15A, the supply tubes 306 in this example are equivalently coupled to the top side of the lower end of the first duct 210. As such, the airflow is split in either implementation into primary and secondary airflow paths, namely a negative (or pull) airflow path and the additional positive (or push) airflow path.

In some examples, the cotton flow accelerators 300 are also configured to provide connection to adjacent stripper row unit augers 158 (e.g., to a pair of the stripper row unit augers 158) having different spacing and/or widths by adjusting one or more components of the stripper row unit augers 158 as described in more detail herein. The cotton flow accelerators 300 have components parts that are configured to allow for connection to the stripper row unit augers 158 in different configurations. As such, the herein described duct structures can be easily modified to couple to different arrangements of the cross auger structure.

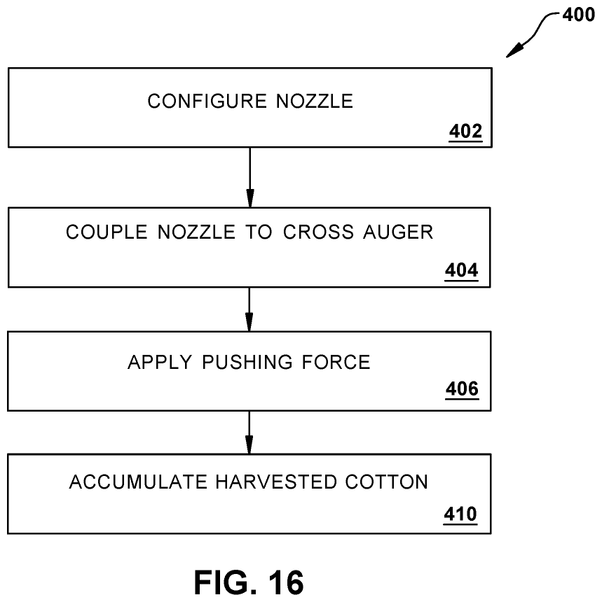

In various examples, the cotton flow accelerators 200, 300 provide an additional airflow that improves flow rate capacity. A harvester with improved flow (e.g., improved harvesting capacity) is thereby provided, resulting in improved overall operation in some examples. For example, the cotton flow accelerators 200, 300 allow less cotton to be lost when harvesting with the stripper row unit augers 158 by moderating the force of the airflow at the cross auger 202. The flowchart 400 (shown in FIG. 16) illustrates operations involved in configuring an airflow accelerator in a cotton stripper according to various implementations. In some examples, the operations of the flowchart 400 are performed using one or more configurations described in more detail herein.

More particularly, the flowchart 400 commences at 402, which includes configuring a nozzle to provide a positive airflow at a cotton inlet. In some examples, the pushing force results at the header exit using the positive airflow. For example, the nozzle 216 or nozzle 304 is configured to provide a pushing airflow at the cross auger 202. In various examples, the nozzle 216 or nozzle 304 is configured (e.g., sized, shaped, etc.) to introduce airflow at the cross auger 202. That is, the nozzle 216 or nozzle 304 provides additional cotton conveyance airflow directly to the cross auger 202 by redirecting air or supplying air to a portion of the cross auger 202. In various examples, the nozzle 216 or nozzle 304 provides a cotton inlet that is configured to allow for incoming airflow (e.g., pushing air) in a different direction and/or from a different location. In various examples, the configured nozzle directs an airflow to define a positive airflow at an exit of the cross auger 202. However, the nozzle can be configured to define a positive airflow at different locations relative to the cross auger 202.

At 404, the nozzle is coupled to a cross auger. For example, the nozzle 216 or nozzle 304 is coupled to be positioned at a front end or lower end of the cross auger 202 as described in more detail herein. That is, one or more air supply ducts, tube, hoses, etc. are used to connect an air source (e.g., the fan 208) through a conduit to the nozzle 216 or nozzle 304 coupled adjacent to the cross auger 202. As should be appreciated, the position, orientation, etc. of the nozzle 216 or nozzle 304 can be varied as desired or needed, such as based on the configuration of the cross auger 202. In some examples, additional components are also coupled along with the nozzle 216 or nozzle 304, such as the guard 256 to protect portions of the nozzle 216 or nozzle 304 or other elements described herein.

At 406, a pushing force is applied to facilitate improved harvesting of stripped cotton. For example, one or more fans are operated to create a pushing force (positive airflow) at the cross auger 202 as described in more detail herein and that causes more harvested cotton to pass into the cotton stripper lower transition duct 212, wherein the harvested cotton is then accumulated and exposed to higher induced flow at 410. That is, with the nozzle 216 or nozzle 304, less crop is lost in finger grates when induced airflow is reduced.

Thus, various examples provide improved harvester flow, including increased throughput while reducing the likelihood of clogging. As such, more cotton can be harvested in a shorter period of time with less likelihood of delays due to blockage in various examples.

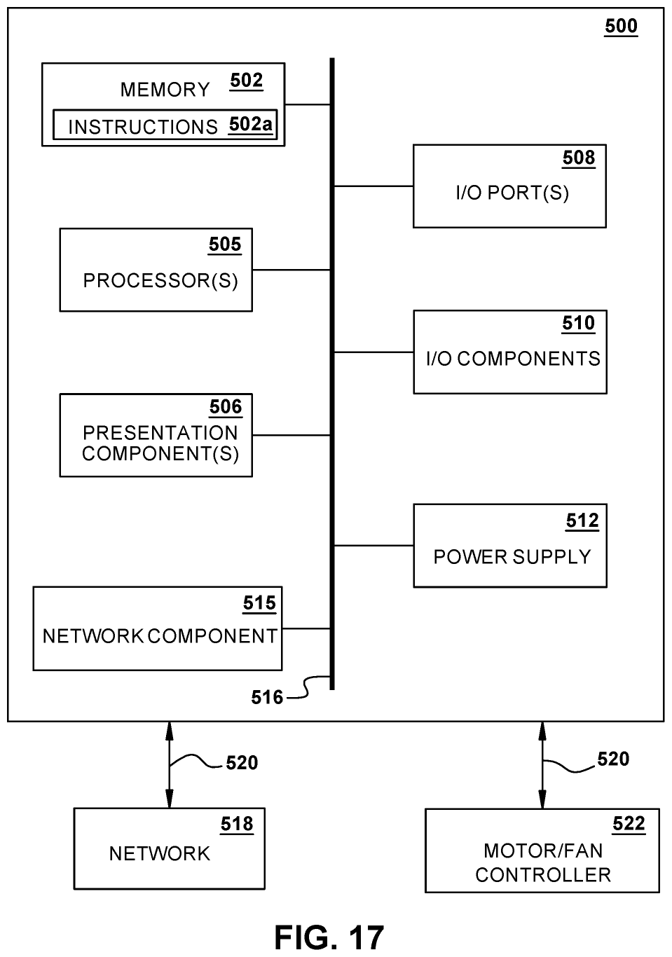

With reference now to FIG. 17, a block diagram of a computing device 500 suitable for implementing various aspects of the disclosure as described (e.g., operations or functions of the operator interface 128 or controller thereof). For example, in operation, the computing device 500 is operable with a motor controller 522 to control operation (e.g., pushing force) of one or more motors that cause cotton material to be harvested. FIG. 17 and the following discussion provide a brief, general description of a computing environment in/on which one or more or the implementations of one or more of the methods and/or system set forth herein may be implemented. The operating environment of FIG. 17 is merely an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, mobile consoles, tablets, media players, and the like), multiprocessor systems, consumer electronics, mini computers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

In some examples, the computing device 500 includes a memory 502, one or more processors 504, and one or more presentation components 506. The disclosed examples associated with the computing device 500 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 17 and the references herein to a “computing device.” The disclosed examples are also practiced in distributed computing environments, where tasks are performed by remote-processing devices that are linked through a communications network. Further, while the computing device 500 is depicted as a single device, in one example, multiple computing devices work together and share the depicted device resources. For instance, in one example, the memory 502 is distributed across multiple devices, the processor(s) 504 provided are housed on different devices, and so on.

In one example, the memory 502 includes any of the computer-readable media discussed herein. In one example, the memory 502 is used to store and access instructions 502a configured to carry out the various operations disclosed herein. In some examples, the memory 502 includes computer storage media in the form of volatile and/or nonvolatile memory, removable or non-removable memory, data disks in virtual environments, or a combination thereof. In one example, the processor(s) 504 includes any quantity of processing units that read data from various entities, such as the memory 502 or input/output (I/O) components 510. Specifically, the processor(s) 504 are programmed to execute computer-executable instructions for implementing aspects of the disclosure. In one example, the instructions 502a are performed by the processor 504, by multiple processors within the computing device 500, or by a processor external to the computing device 500. In some examples, the processor(s) 504 are programmed to execute instructions such as those illustrated in the flow charts discussed herein and depicted in the accompanying drawings.

In other implementations, the computing device 500 may include additional features and/or functionality. For example, the computing device 500 may also include additional storage (e.g., removable and/or non-removable) including, but not limited to, magnetic storage, optical storage, and the like. Such additional storage is illustrated in FIG. 17 by the memory 502. In one implementation, computer readable instructions to implement one or more implementations provided herein may be in the memory 502 as described herein. The memory 502 may also store other computer readable instructions to implement an operating system, an application program and the like. Computer readable instructions may be loaded in the memory 502 for execution by the processor(s) 504, for example.

The presentation component(s) 506 present data indications to an operator or to another device. In one example, the presentation components 506 include a display device, speaker, printing component, vibrating component, etc. One skilled in the art will understand and appreciate that computer data is presented in a number of ways, such as visually in a graphical user interface (GUI), audibly through speakers, wirelessly between the computing device 500, across a wired connection, or in other ways. In one example, the presentation component(s) 506 are not used when processes and operations are sufficiently automated that a need for human interaction is lessened or not needed. I/O ports 508 allow the computing device 500 to be logically coupled to other devices including the I/O components 510, some of which is built in. Implementations of the I/O components 510 include, for example but without limitation, a microphone, keyboard, mouse, joystick, pen, game pad, satellite dish, scanner, printer, wireless device, camera, etc.

The computing device 500 includes a bus 516 that directly or indirectly couples the following devices: the memory 502, the one or more processors 504, the one or more presentation components 506, the input/output (I/O) ports 408, the I/O components 510, a power supply 512, and a network component 514. The computing device 500 should not be interpreted as having any dependency or requirement related to any single component or combination of components illustrated therein. The bus 516 represents one or more busses (such as an address bus, data bus, or a combination thereof). Although the various blocks of FIG. 9 are shown with lines for the sake of clarity, some implementations blur functionality over various different components described herein.

The components of the computing device 500 may be connected by various interconnects. Such interconnects may include a Peripheral Component Interconnect (PCI), such as PCI Express, a Universal Serial Bus (USB), firewire (IEEE 1394), an optical bus structure, and the like. In another implementation, components of the computing device 500 may be interconnected by a network. For example, the memory 502 may be comprised of multiple physical memory units located in different physical locations interconnected by a network.

In some examples, the computing device 500 is communicatively coupled to a network 418 using the network component 514. In some examples, the network component 514 includes a network interface card and/or computer-executable instructions (e.g., a driver) for operating the network interface card. In one example, communication between the computing device 500 and other devices occurs using any protocol or mechanism over a wired or wireless connection 520. In some examples, the network component 514 is operable to communicate data over public, private, or hybrid (public and private) connections using a transfer protocol, between devices wirelessly using short range communication technologies (e.g., near-field communication (NFC), Bluetooth® branded communications, or the like), or a combination thereof.

The connection 520 may include, but is not limited to, a modem, a Network Interface Card (NIC), an integrated network interface, a radio frequency transmitter/receiver, an infrared port, a USB connection or other interfaces for connecting the computing device 500 to other computing devices. The connection 520 may transmit and/or receive communication media.

Although described in connection with the computing device 500, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure, such as controllers or monitors, are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A cotton flow accelerator for a cotton stripper, the airflow accelerator comprising:
an air source;
a nozzle having an inlet configured to receive an airflow from the air source and an outlet configured to direct airflow pushing cotton away from a cross auger; and
one or more ducts coupling the nozzle to the air source to form an air path therethrough, wherein the nozzle is coupled adjacent to the cross auger and directs the airflow to define a positive airflow at the cross auger.

2. The cotton flow accelerator according to claim 1, wherein the nozzle comprises a curved portion that forms one or more of:
a generally J-shaped body; and/or
a generally L-shaped body.

3. The cotton flow accelerator according to claim 1, wherein the nozzle comprises one or more of:
an outlet configured to direct airflow from a front of the cross auger and tangential to a bottom of the cross auger;
an outlet configured to direct airflow at an angle relative to a bottom of the cross auger;
and/or an outlet configured to introduce airflow at an exit of the cross auger.

4. The cotton flow accelerator according to claim 1, wherein the one or more ducts comprises an angled tube configured to connect in a plurality of different arrangements having different orientations relative to the cross auger.

5. The cotton flow accelerator according to claim 1, further comprising a guard coupled adjacent to the nozzle.

6. The cotton flow accelerator according to claim 1, wherein the air source comprises:
a fan configured to supply air to a plurality of air pathways through different ducts of the one or more ducts,
wherein the fan is configured to supply air to generate an additional airflow, wherein the additional airflow is a negative airflow downstream of the cross auger,
wherein the fan comprises a plurality of rotors coupled to the different ducts.

7. The cotton flow accelerator according to claim 1, wherein the air source comprises a plurality of fans configured to supply air to a plurality of air pathways through different ducts of the one or more ducts.

8. The cotton flow accelerator according to claim 1, wherein the nozzle is configured to direct the airflow to define a positive airflow at the cross auger, whereby cotton is pushed out of an exit of the cross auger and into a cotton stripper lower transition duct.

9. The cotton flow accelerator according to claim 1, wherein the airflow is split into primary and secondary airflow paths comprising a negative airflow path operable to pull cotton through the cotton flow accelerator, and an additional positive airflow path operable to push the cotton through the cotton flow accelerator.

10. A harvester vehicle comprising:
a header system that includes a crop header component, wherein the crop header components comprises a cotton stripper header including a cross auger; and
an air system comprising an air source and operably coupled to, and in communication with, the header system, the air system further comprising a cotton flow accelerator comprising:
a nozzle having an inlet configured to receive air from the air source and an outlet configured to direct airflow relative to a cross auger, and
one or more ducts coupling the nozzle to the air source to form an air path therethrough, wherein the nozzle is coupled adjacent to the cross auger and directs the airflow to define a positive airflow at the cross auger.

11. The harvester vehicle of claim 10, wherein the nozzle of the cotton flow accelerator comprises one or more of:
a curved portion that forms a generally J-shaped body; and/or
a curved portion that forms a generally L-shaped body.

12. The harvester vehicle of claim 10, wherein the nozzle of the cotton flow accelerator comprises one or more of:
an outlet configured to direct airflow from a front of the cross auger and tangential to a bottom of the cross auger;
an outlet configured to direct airflow at an angle relative to a bottom of the cross auger;
and/or an outlet configured to introduce airflow at an exit of the cross auger.

13. The harvester vehicle of claim 10, wherein the air source comprises a plurality of fans configured to supply air to a plurality of air pathways through different ducts of the one or more ducts.

14. The harvester vehicle of claim 10, wherein the nozzle is configured to direct the airflow to define a positive airflow at the cross auger, whereby cotton is pushed out of an exit of the cross auger and into a cotton stripper lower transition duct.

15. The harvester vehicle of claim 10, wherein the air source comprises:
a fan configured to supply air to a plurality of air pathways through different ducts of the one or more ducts,
wherein the fan is configured to supply air to generate an additional airflow, wherein the additional airflow is a negative airflow downstream of the cross auger,
wherein the fan comprises a plurality of rotors coupled to the different ducts.

16. The harvester vehicle of claim 10, wherein the air source comprises a plurality of fans configured to supply air to a plurality of air pathways through different ducts of the one or more ducts.

17. The harvester vehicle of claim 10, wherein the nozzle is configured to direct the airflow to define a positive airflow at the cross auger, whereby cotton is pushed out of an exit of the cross auger and into a cotton stripper lower transition duct.

18. The harvester vehicle of claim 10, wherein the airflow is split into primary and secondary airflow paths comprising a negative airflow path operable to pull cotton through the cotton flow accelerator, and an additional positive airflow path operable to push the cotton through the cotton flow accelerator.

19. A method for configuring a cotton flow accelerator in a cotton stripper, the method comprising:
configuring a nozzle to provide a positive airflow at a cotton inlet, wherein the nozzle comprises a curved portion to direct the positive airflow;
coupling the nozzle to a cross auger of the cotton stripper and to an air source; and
operating the nozzle to apply a pushing force at a header exit using the positive airflow.

20. A method for configuring a cotton flow accelerator in a cotton stripper according to claim 19, further comprising:
coupling the cross auger of the cotton stripper to a negative airflow path operable to additionally pull cotton from the header exit using the negative airflow path.
